(19) United States
(12) Patent Application Publication
(10) Pub. No.: US 2009/0077765 A1
(43) Pub. Date: Mar. 26, 2009

(54) Cylndrical member conditioning device

(76) Inventors: Steven A. Heumann, Windsor, CA (US); Richard D. Howard, Windsor, CA (US)

Correspondence Address: DERGOSITS & NOAH LLP, FOUR EMBARCADERO CENTER, SUITE 1450, SAN FRANCISCO, CA, 94111, US

(21) Appl. No.: 11/904,244

(22) Filed: Sep. 25, 2007

(51) Int. Cl. B08B 1/02; B08B 5/04

(52) U.S. Cl. 15/309.1; 15/236.06

(57) ABSTRACT

A cylindrical member conditioning device. The device includes a housing having a longitudinal axis and a passageway extending along the longitudinal axis, the passageway being of sufficient size to receive the cylindrical member and to facilitate its movement through the housing. The housing includes at least one roller pair, each roller of the roller pair having an axis substantially perpendicular to the longitudinal axis. Each roller is rotatable about its axis, the rollers of the roller pair positioned on opposite sides of the longitudinal axis. The surface of each roller is sized to extend sufficiently into the passageway such that as the cylindrical member passes through the housing, the rollers change a surface condition thereof.

### TECHNICAL FIELD

The present invention involves a cylindrical member conditioning device capable of changing a surface condition of the cylindrical member. As an example, the present device can be moved along a braided cable, the braided cable, when used on, for example, suspension bridges, is subjected to multiple coats of paint over time. This device can fracture the paint layers enabling downstream conditioning devices to remove the paint layers more easily for subsequent cleaning and repainting.

### BACKGROUND OF THE INVENTION

As noted above, braided steel cable, such as the type used on suspension bridges, is comprised of a plurality of braided strands helically wrapped around a solid core. The cable is made of steel and thus requires periodic maintenance to prevent rusting. Such maintenance is comprised of removing surface dirt, rust and old paint, followed by repainting the clean surface.

A typical cleaning device for cleaning braided steel cables is comprised of a housing which positions wire brushes around a cable. When the cleaning device is moved along the cable, the cable is cleaned by the wire brushes. Some cleaning devices apply a cleaning fluid. The prior art cable cleaners can clean the lands of the cable, that is, the outer most parts of the strands, but cannot clean deep inside the groove between adjacent strands. Also, the wire brushes wear out quickly. Further, debris and cleaning fluids fly out from the cleaning devices as environmental contaminants.

Applicants have been awarded U.S. Pat. No. 6,990,707, the disclosure of which is incorporated by reference herein. This device is shown in FIG. 4 comprised of a housing 50 in the form of two half housings 51 and 52 hinged together for opening and closing around cylindrical member 19, such as braided steel cable. Alternatively, half housings 51 and 52 may be completely detachable from each other. The cleaner can be used for cleaning other types of cylindrical members, such as pipes. Half housings 51 and 52 are locked together by latches 54 after they are closed around cylindrical member 19. Split alignment rings 55 and 56 in the housing aligns cylindrical member 19 therein and seal the interior of housing 50 from the outside environment. A split sealing ring 57 is positioned at a first end of housing 50. Sealing ring 57 has a slightly larger inner diameter than those of alignment rings 55 and 56 to avoid touching the cylindrical member 19. Rings 55-57 are comprised of two half rings 59 and 60 attached to respective half housings 51 and 52, so that rings 55-57 can be opened and closed around cylindrical member 19.

Rotary helical brush assemblies 61 and a rotary longitudinal brush assembly 62 are positioned in housing 50 and rotatable about an axis thereof. As taught in the '707 patent, there may be any number of each type of brush assembly. Rotary helical brush assembly 61 is comprised of coaxial split rings 63 connected by spacers 64 and rotary cylindrical wire brushes 65 in a helical arrangement. Rotary longitudinal brush assembly 62 is comprised of coaxial split rings 66 connected by spacers 67 and cylindrical wire brushes 68 in a longitudinal arrangement. The brushes in either brush assembly are independently rotatable about their own axle 97. Each brush assembly can be opened and closed around cylindrical member 19.

Nozzles 69 are positioned inside housing 50 and a space between brush assembly 61 and sealing ring 57 for applying a material to cylindrical member 19, such as a chemical cleaner, steam, abrasives, paint, etc. Nozzles 69 are connected by hoses 70 to a distribution chamber 71 attached to the outside of housing 50. Suction apertures 72 in housing 50 are for connecting to a suction device depicted in FIG. 2 for removing debris and waste fluid from inside housing 50 to avoid contaminating the outside environment.

Although the cylindrical member maintenance device disclosed and claimed in applicants' prior '707 patent represented a dramatic advancement in the art of cleaning and maintaining cylindrical members such as braided steel cables, it has been recognized that the overall process of stripping debris such as layered paint and rust could be dramatically improved by preconditioning the cylindrical member surface prior to its introduction to the cylindrical member maintenance device as depicted in FIG. 4. In this regard, reference is made to FIG. 1.

### SUMMARY OF THE INVENTION

A cylindrical member conditioning device. The device includes a housing having a longitudinal axis and a passageway extending along the longitudinal axis, the passageway being of sufficient size to receive the cylindrical member and to facilitate its movement through the housing. The housing includes at least one roller pair, each roller of the roller pair having an axis substantially perpendicular to the longitudinal axis. Each roller is rotatable about its axis, the rollers of the roller pair positioned on opposite sides of the longitudinal axis. The surface of each roller is sized to extend sufficiently into the passageway such that as the cylindrical member passes through the housing, the rollers change a surface condition thereof.

### BRIEF DESCRIPTION OF THE DRAWINGS

FIG. 1 is a side plan view of the present invention in which a portion of the housing of the cylindrical member conditioning device has been removed to provide the details of the internal components thereof;

FIG. 2 is a side plan view of the outer housing of the present invention pursuant to one embodiment thereof;

FIG. 3 is a side plan view of a roller used herein to describe its preferred embodiment; and

FIG. 4 is a side plan view of the maintenance device disclosed in U.S. Pat. No. 6,990,707 for use herein.

### DETAILED DESCRIPTION OF THE INVENTION

Cylindrical member conditioning device 10 is shown having housing 11 which can be cylindrical, square or rectangular in cross section, the front surface of which is removed to show the internal working components thereof.

Cylindrical member conditioning device 10 includes housing 11 having longitudinal axis 9 and passageway 18, said passageway 18 being of sufficient size to receive cylindrical member 19 which, again, can be cables typically used on bridges having paint, dirt, rust and other debris on its surface.

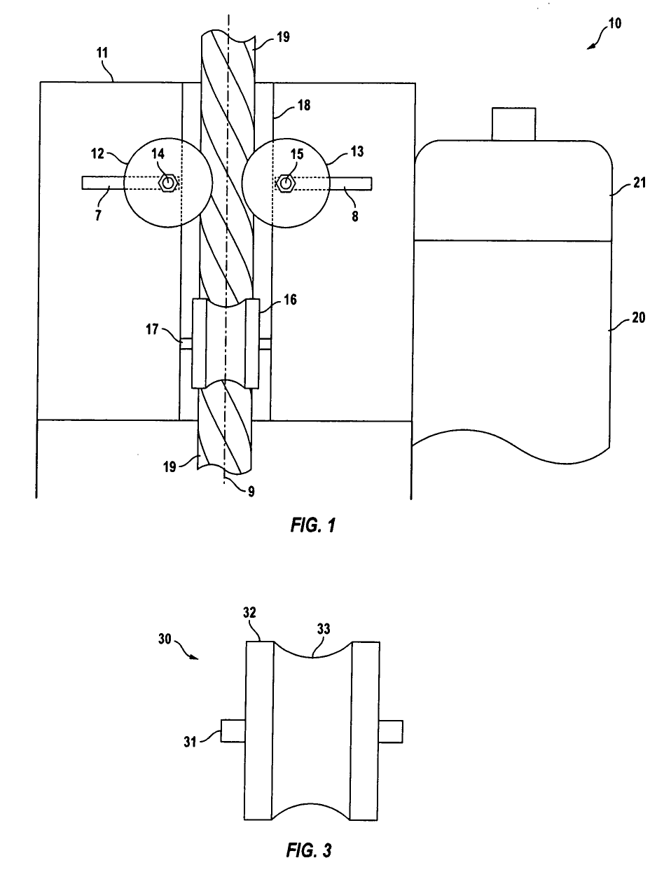

Cylindrical member conditioning device 10 is provided with at least one roller pair 12 and 13, FIG. 1 depicting half of a second roller pair 16, each roller of the roller pair having an axis depicted in FIG. 1 as axes 14, 15 and 17 substantially perpendicular to longitudinal axis 9. Each roller is rotatable about its axis, the rollers of the roller pairs positioned on opposite sides of longitudinal axis 9 and the surface of each roller sized to extend sufficiently into passageway 18 such that as said cylindrical member passes through said housing, said rollers change surface condition thereof.

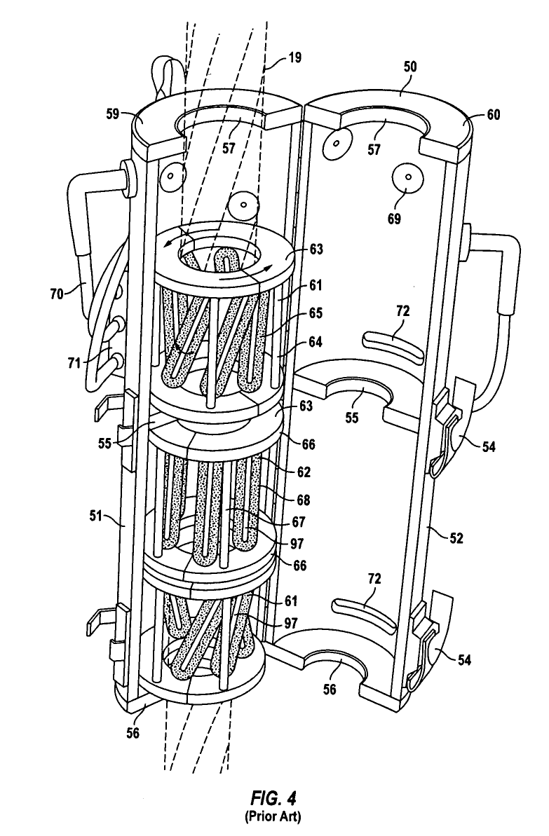

In preparing to receive cylindrical member 19, the radial size of the cylindrical member is determined and rollers positioned to extend within passageway 18 to intrude upon and break up coated layers on cylindrical member 19. Axes 14 and 15 can be moved along passageways 7 and 8 and once the appropriate spacing has been determined, can be bolted down to affix axes 14 and 15 to extend rollers 12 and 13 into passageway 18 as desired. Thus, as housing 11 is moved along cylindrical member 19, the surface condition of cylindrical member 19 is changed, in most instances, by enabling rollers 14, and the roller pair defined by roller 16 to fracture unwanted paint layers existing thereupon, later be processed by the combination as further described regarding FIG. 4.

In accomplishing the goal of the present invention, in most instances, each roller should be provided with a profile as best depicted by referring to FIG. 3. As noted, roller 30 is provided with axis to 31 upon which it is to rotate. The roller has a curved profile enabling roller 30 to maximize its surface area contact with the appropriate cylindrical member by creating a center most reduced diameter in area 33 as compared to its boundary dimension at 32.

It should also be appreciated that the present invention operates, as noted above, by providing roller pairs. In this way, the cylindrical member is pinched between opposing rollers which enhances the ability of the present invention to change a surface condition thereof. Ideally, adjacent roller pairs should be positioned about passageway 18 and longitudinal axis 9 such that substantially the entire surface of cylindrical member 19 is impacted thereby. In the example shown in FIG. 1, the roller pair characterized by rollers 12 and 13 is perpendicular to the roller pair defined by roller 16. Alternatively, a series of multiple roller pairs could be positioned 30, 60, 90 or 120 degrees about longitudinal axis 9, again, in providing maximum contact between the roller pairs and the cylindrical member to ensure that the present invention does, in fact, change a surface condition as desired.

It is quite possible that debris will be created within housing 11 which either can be removed therefrom or downstream when cylindrical member 19 confronts a further maintenance device as depicted in FIG. 4. If debris is intended to be removed from housing 11, a suction distribution chamber can be provided connected to suction aperture such as that disclosed in the '707 patent. As shown in FIG. 1, a receptacle 20 can be strapped to housing 11 for catching debris drawn from housing 11 and emptied by remaining lid 21. Again, the appropriate suction distribution chamber and related hardware can be provided in the maintenance device as shown in FIG. 4.

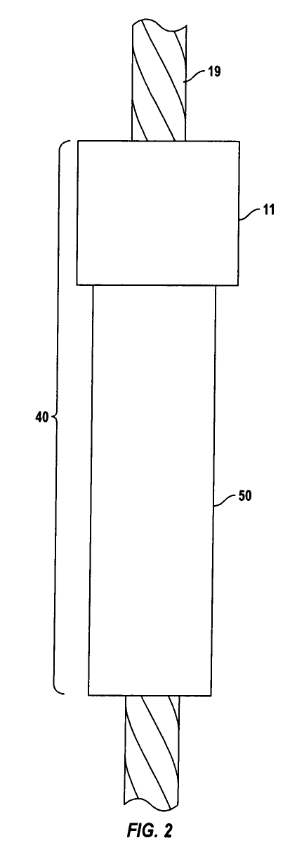

A unitary cylindrical member conditioning and maintenance device can be provided as shown in FIG. 2 by connecting housing 11 and housing 50 constituting overall structure 40. It is intended that structure 40 move along cylindrical member 19 whereby the conditioning device within housing 11 is first caused to impact the surface of cylindrical member 19 before maintenance device 50 further impacts the surface. In most instances, housings 11 and 50 will be separated and move along cylindrical member 19 independently of one another.

The details of maintenance device 51 is depicted in FIG. 4. The components of this device are described in U.S. Pat. No. 6,900,707, the disclosure of which is incorporated by reference herein. Specifically, cylindrical member maintenance device is shown in perspective view in FIG. 4 in an open position. It is comprised of housing 50 having two half housings 51 and 52 hinged together for opening and closing around cylindrical member 19 which has been described previously.

When the cylindrical member conditioning/maintenance device is used for cleaning steel cable, it may be moved in an upward direction along the steel cable thus enabling housing 11 to first confront the cable prior to housing 50. When the composite device 40 is used for painting a portion of the steel cable, the device may be moved in a downward direction. Ideally, housing 11 will not be employed during the painting operation. Movement of composite device 40 can be had through the attachment of cables to appropriately place loops on housing 11 and/or 50. Again, this is shown in the '707 patent, the disclosure of which is incorporated by reference herein.

What is claimed is:

1. A cylindrical member conditioning device comprising a housing having a longitudinal axis and passageway extending along said longitudinal axis, said passageway being of sufficient size to receive said cylindrical member and to facilitate its movement through said housing, at least one roller pair, each roller of said roller pair having an axis substantially perpendicular to said longitudinal axis, each roller rotatable about its axis, the rollers of said roller pair positioned on opposite sides of said longitudinal axis, the surface of each roller sized extending sufficiently into said passageway such that as said cylindrical member passes through said housing, said rollers change a surface condition thereof.

2. The cylindrical member conditioning device of claim 1 wherein at least two roller pairs are positioned along said longitudinal axis wherein the axis of one roller pair is substantially perpendicular to the axis of said second roller pair.

3. The cylindrical member conditioning device of claim 1 wherein the distance of each roller axis from said longitudinal axis is adjustable.

4. The cylindrical member conditioning device of claim 3 wherein the positioning of said rollers of said roller pair is selected to enable said cylindrical member to pass through said housing along said longitudinal axis while causing each roller to rotate about its axis.

5. The cylindrical member conditioning device of claim 1 wherein said cylindrical member is coated with at least one layer of paint and said roller pair causes substantial fracturing of said paint layer as said cylindrical member passes along said longitudinal axis.

6. The cylindrical member conditioning device of claim 1 wherein ports are provided in said housing for facilitating removal of debris generated by said change in a surface condition of said cylindrical member.

7. The cylindrical member conditioning device of claim 6 wherein suction means are connected to said ports for facilitating debris removal from said housing.

8. The cylindrical member conditioning device of claim 1 further comprising means for moving said housing along said cylindrical member.

9. The cylindrical member conditioning device of claim 1 further comprising a maintenance device positioned adjacent said cylindrical member conditioning device, said maintenance device having a longitudinal axis and passageway along said longitudinal axis aligned with said longitudinal axis and passageway of said cylindrical member conditioning device such that a cylindrical member passing through said housing also passes through the passageway of said maintenance device as said cylindrical member conditioning device and maintenance device are caused to move jointly along said cylindrical member.

10. The cylindrical member conditioning device of claim 1 wherein multiple roller pairs are situated within said housing, each roller pair having axes of rotation perpendicular to said longitudinal axis and said multiple roller pairs, in combination, being of sufficient numbers to change substantially the entire surface of said cylindrical member.

11. The cylindrical member conditioning device of claim 10 whereby each roller of a roller pair is positioned diametrically on opposite sides of said cylindrical member.

12. The cylindrical member conditioning device of claim 11 wherein adjacent roller pairs are positioned 30°, 60°, 90° or 120° about said longitudinal axis.

13. The cylindrical member conditioning device wherein each roller of said roller pair is characterized as having a concave surface profit to maximize surface contact with said cylindrical member as it passes along said longitudinal axis.
